(19) United States
(12) Patent Application Publication
(10) Pub. No.: US 2002/0028705 A1
(43) Pub. Date: Mar. 7, 2002

(54) System and method for generating games and tests

(76) Inventor: Patrick Fitz-Gerald Kelly, San Diego, CA (US)

Correspondence Address: Jonathan Paul, Suite #320, 5280 Carroll Canyon Rd., San Diego, CA, 92121, US

(21) Appl. No.: 09/846,804

(22) Filed: May 1, 2001

Related U.S. Application Data
(60) Provisional application No. 60/201,251, filed on May 1, 2000.

(51) Int. Cl. G06F 19/00; G06F 17/00; A63F 13/00; A63F 9/24

(52) U.S. Cl. 463/2

(57) ABSTRACT

A system and method for creating computer-based simulations, using database entries and menu selections, rather than writing complex software code. A new authoring language is used to enable programming of interactive learning in the form of educational software that may include games, tests and electronic books, where such programming retrieves object based data, such as text or pictures, from a simulation database. The simulation database queries any number of preconditions established by the author and applies a chance value in a range to create an element of randomness for the user to experience. Randomness created with this system provides a realistic experience not available in traditional forms of computer-based learning without advanced computer programming skills and extensive capital investments. The object based programming enabled by the system allows users to update the database with minimal effort to manifest modifications in training techniques and material.

### SUMMARY OF CERTAIN INVENTIVE ASPECTS

One aspect of the invention includes a game authoring system, comprising a first interface for generating a character, and a second interface for generating at least one place visited by the character.

Another aspect of the invention includes a game authoring system, comprising a game authoring tool for generating an electronic game, the electronic game including at least one character and at least one place that is visited by the character, and a game player for playing the electronic game.

Yet another aspect of the invention includes a game authoring tool for generating an electronic game, the game authoring tool comprising at least one interface for defining a player character, a place that is visited by the player character, at least one scene that is played when the user visits the place, and an interactive character having an associated dialog, the player character being able to access the associated dialog by visiting the place and speaking with the interactive character.

### DETAILED DESCRIPTION OF CERTAIN EMBODIMENTS OF THE INVENTION

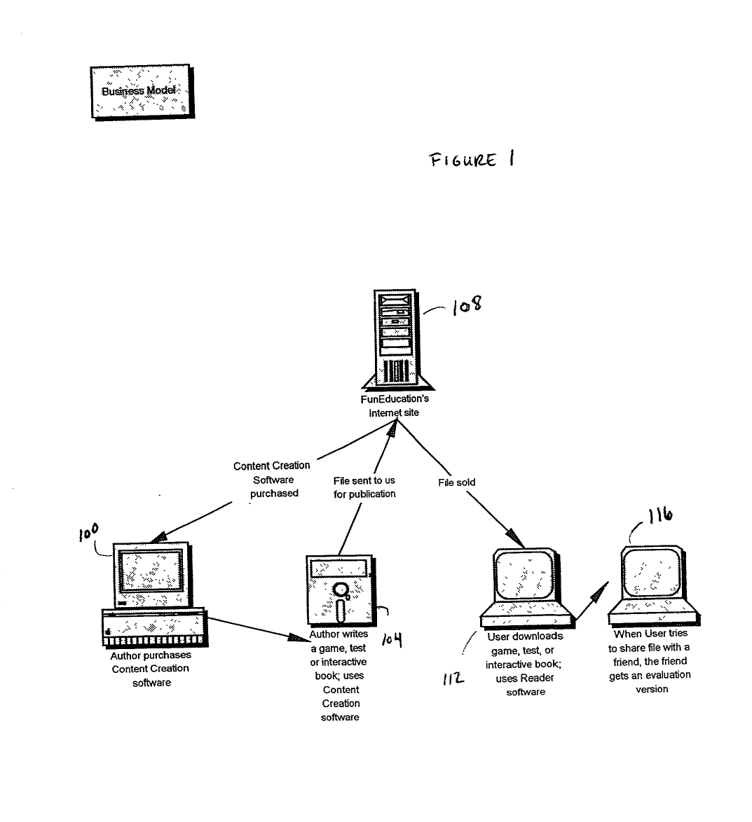

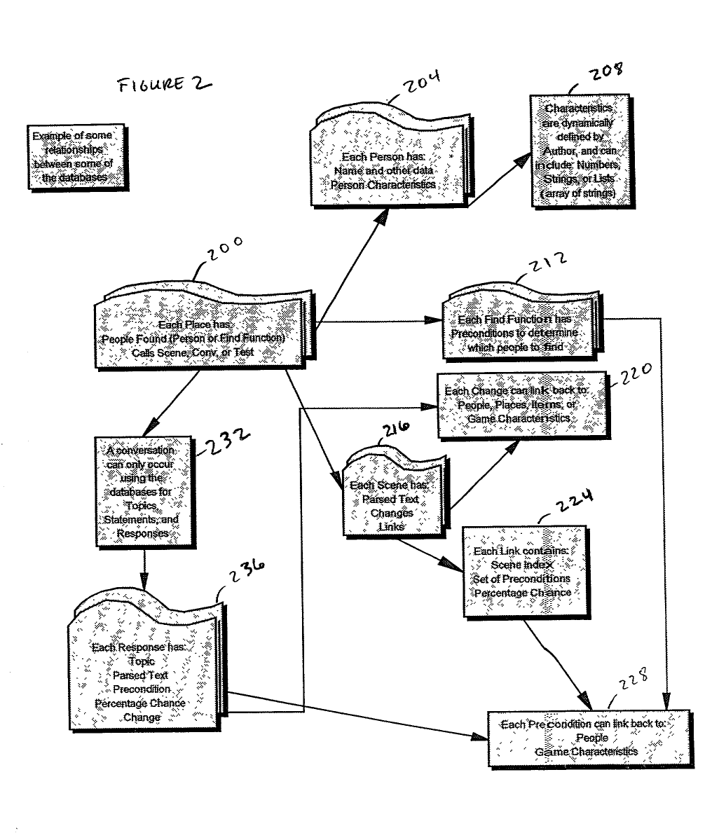

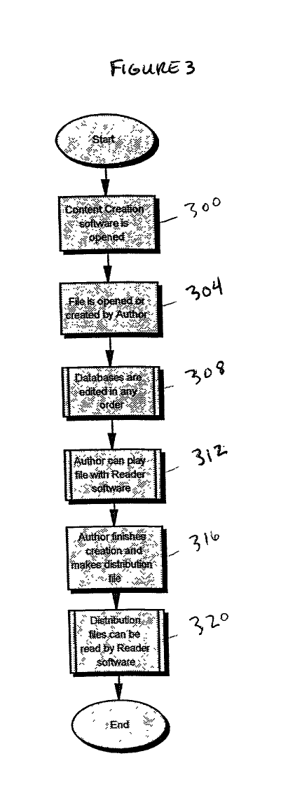

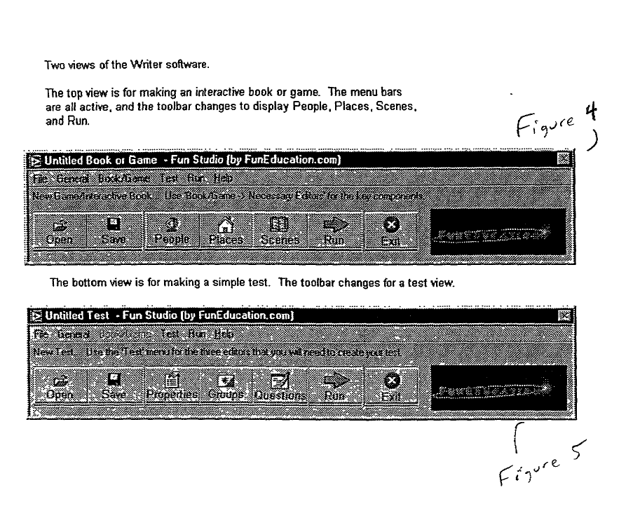

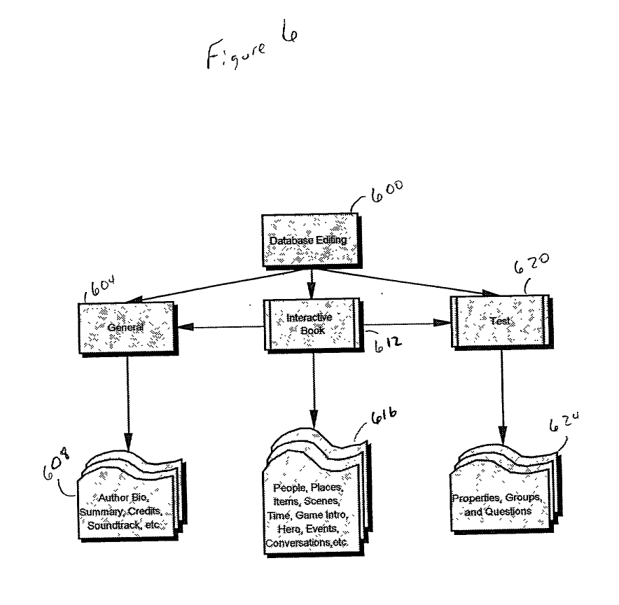

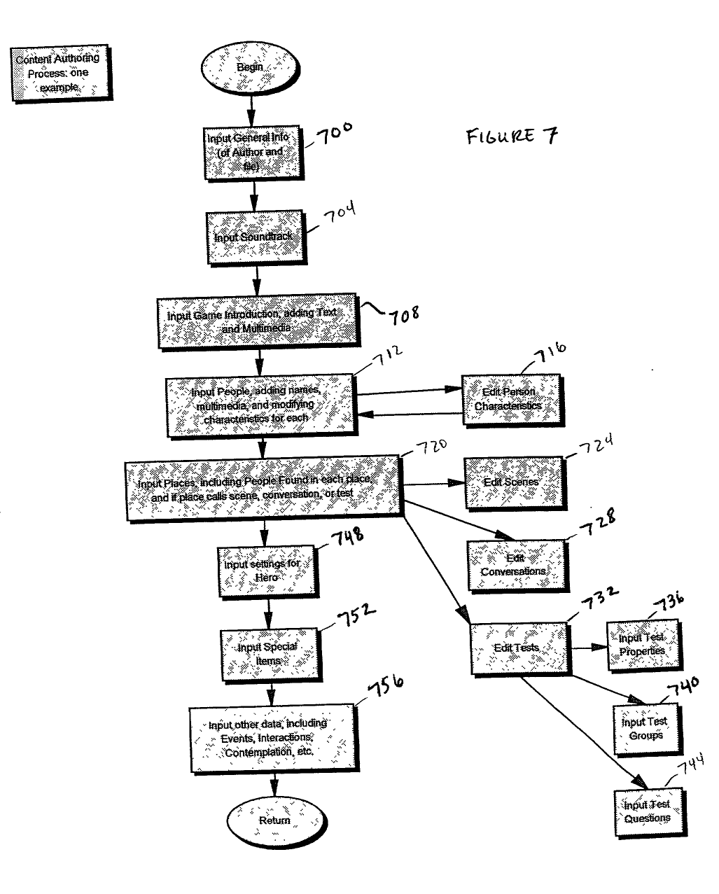

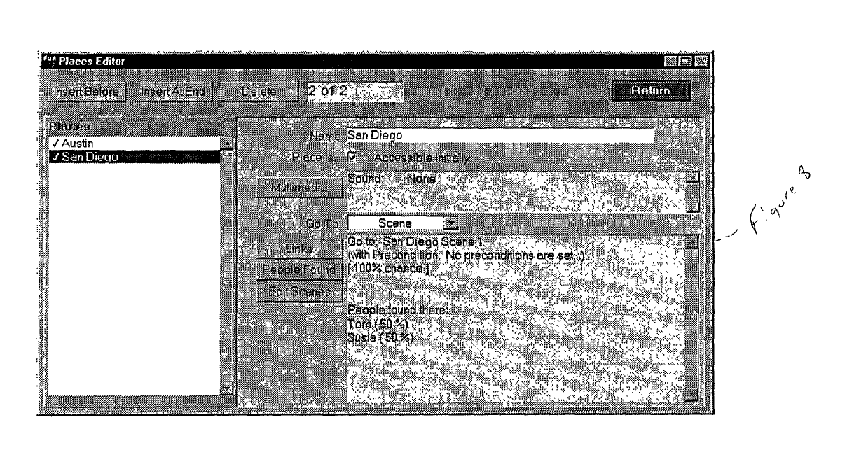

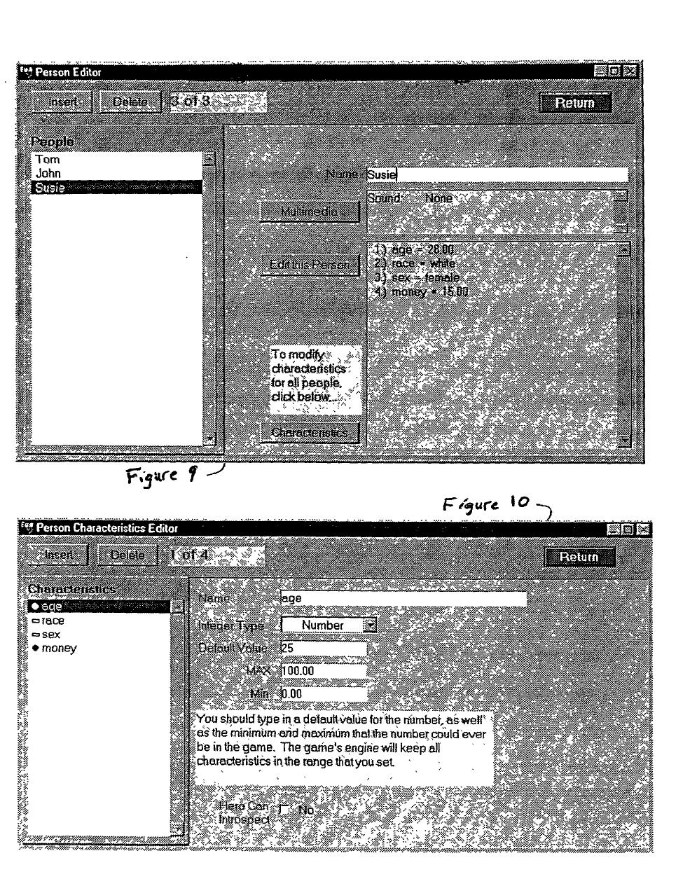

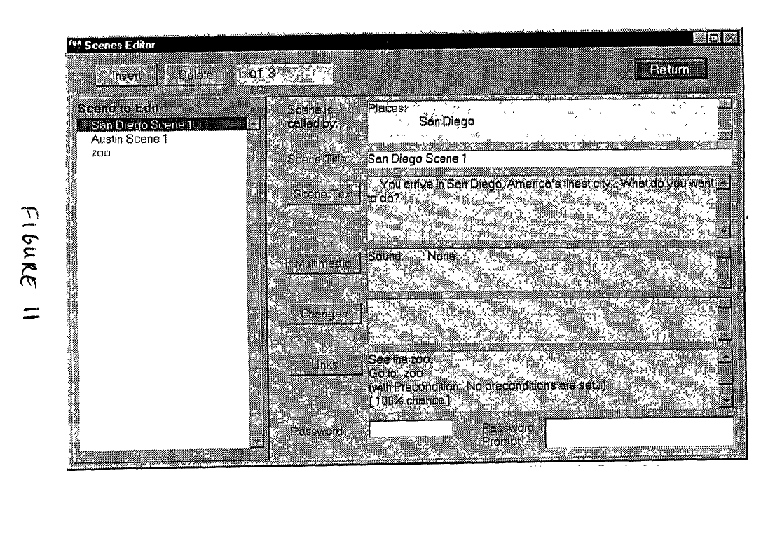

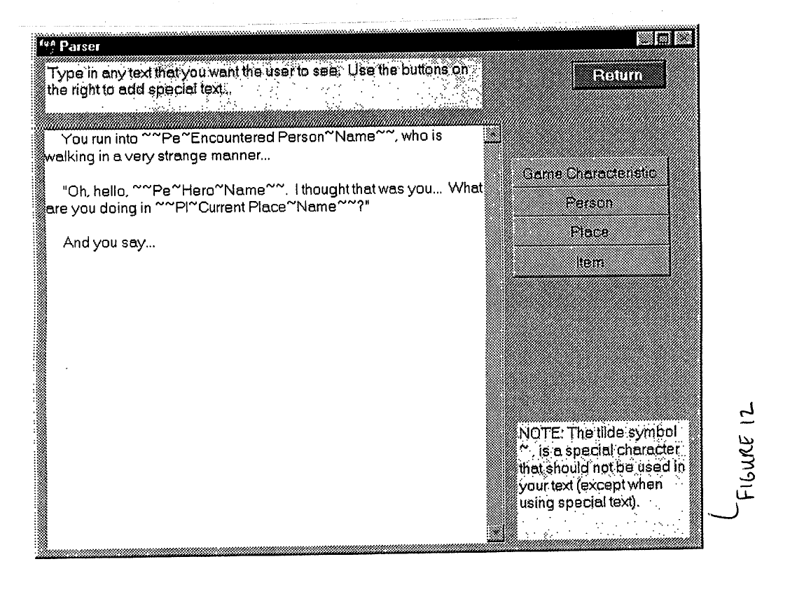

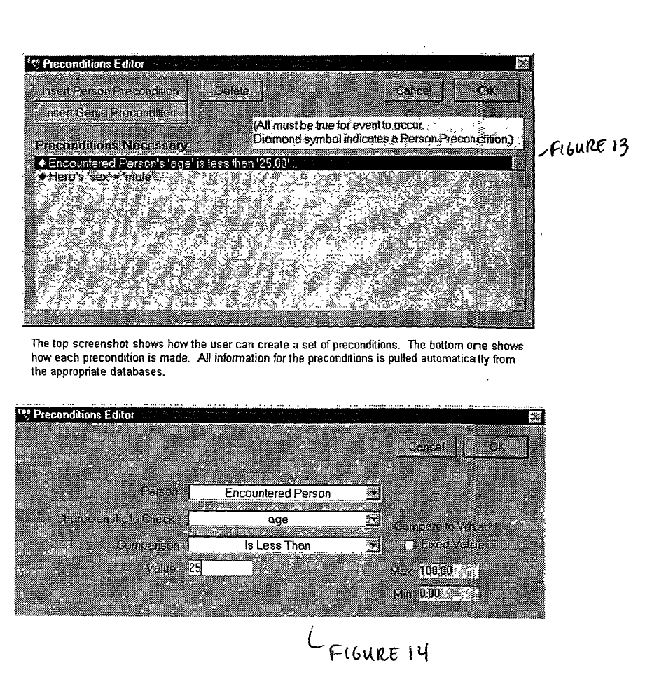

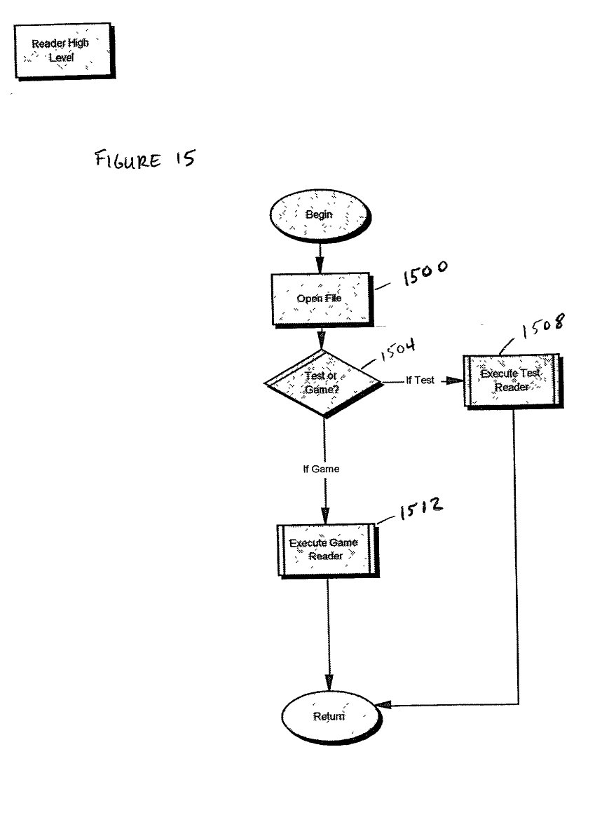

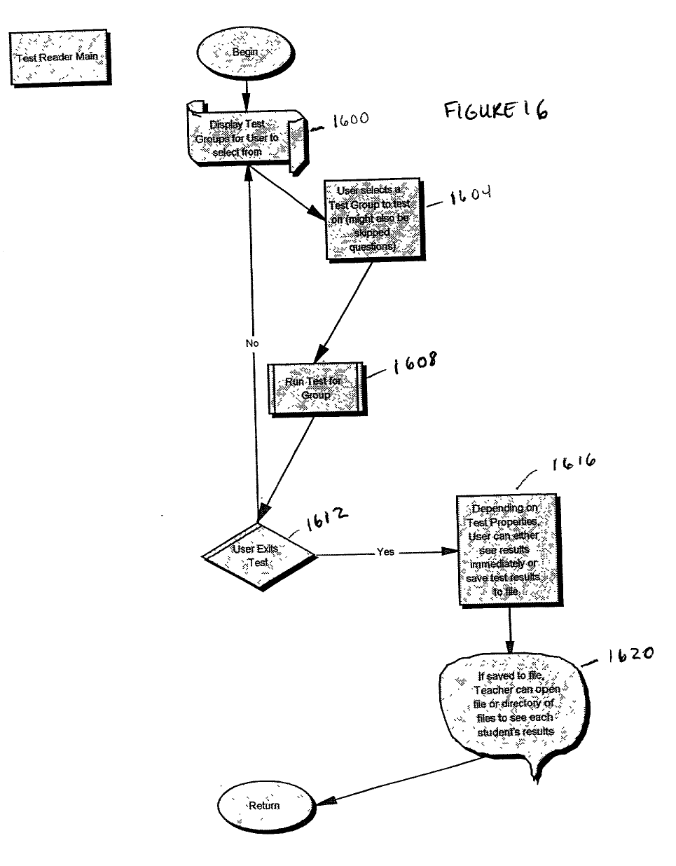

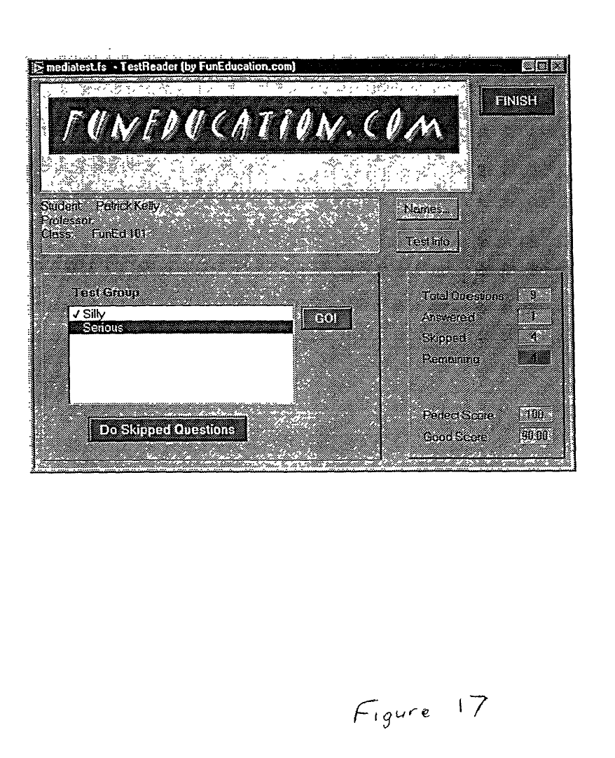

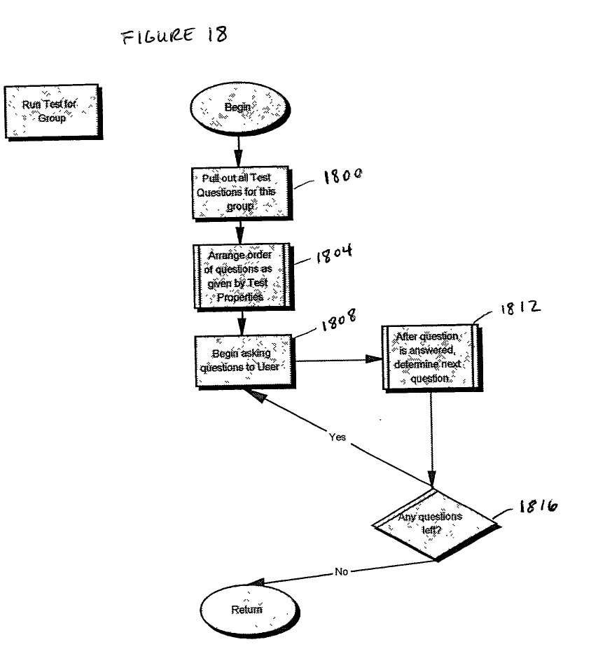

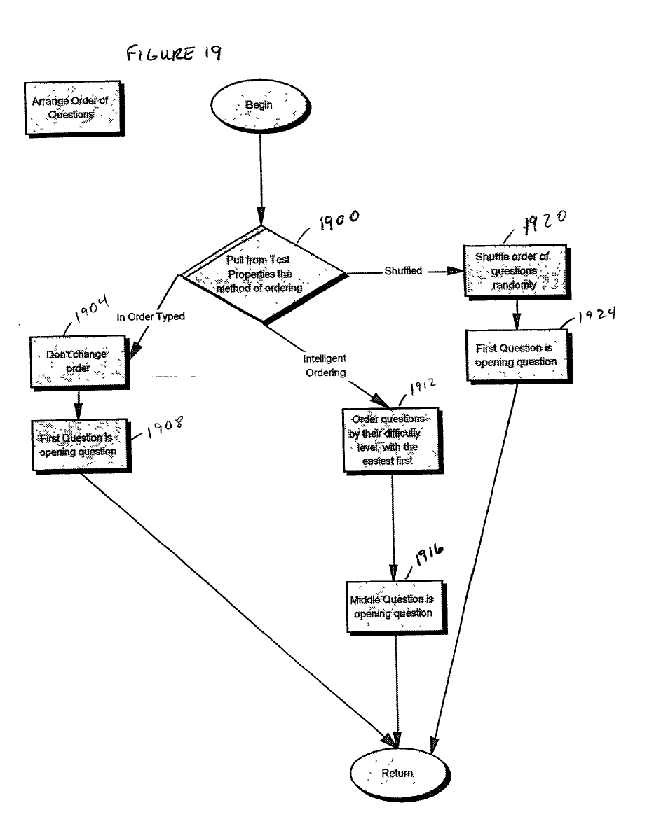

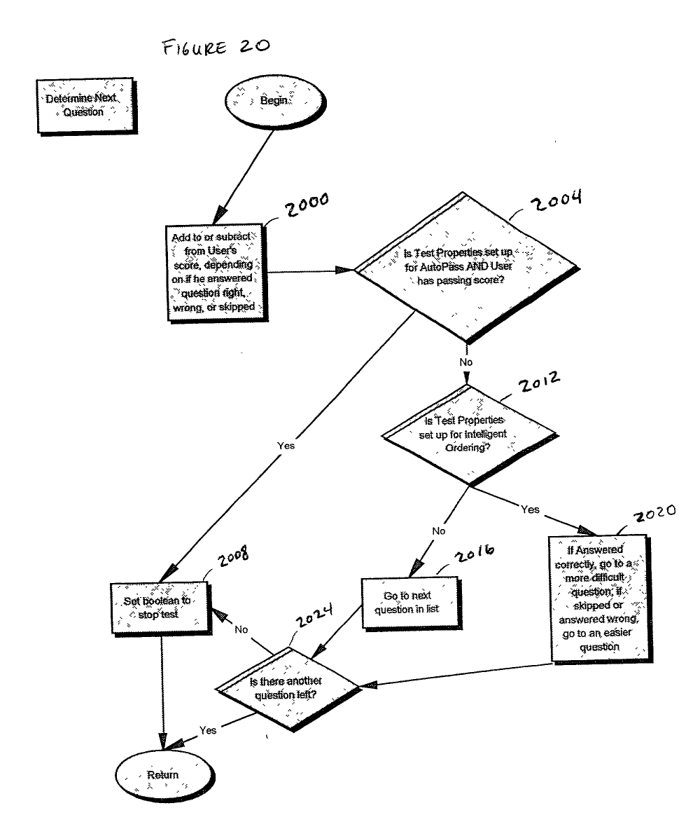

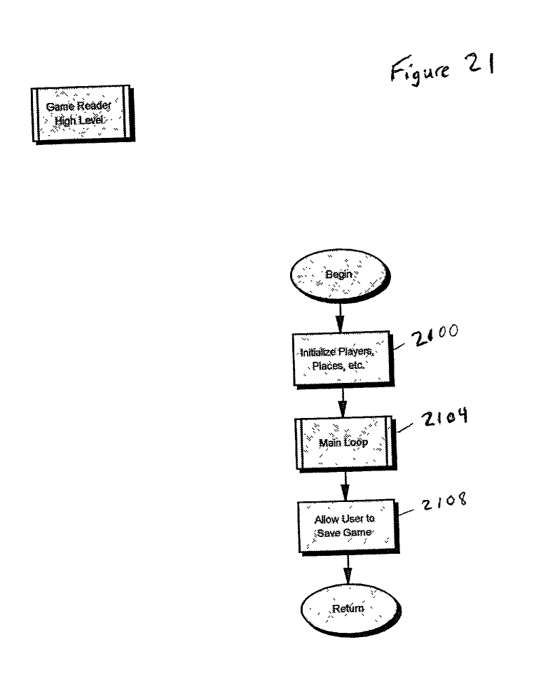

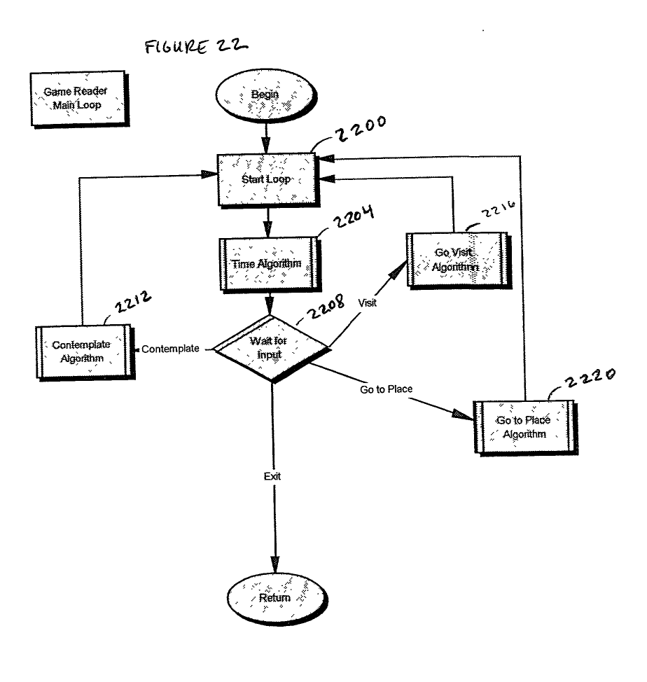

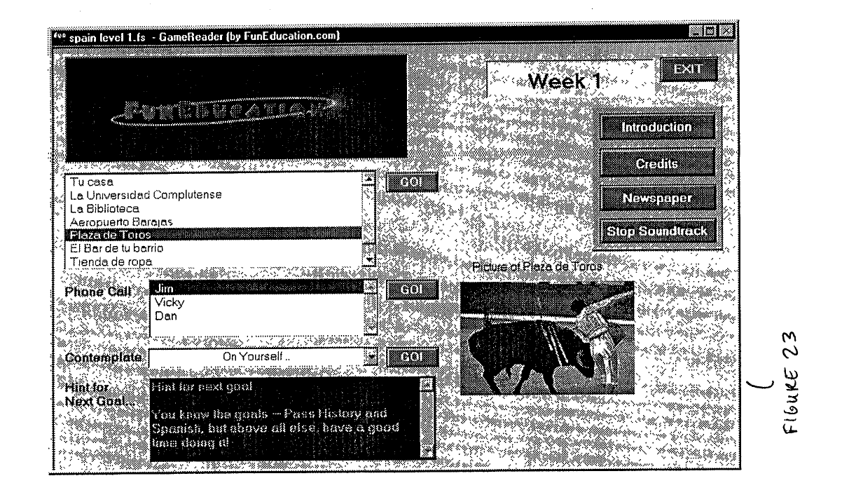

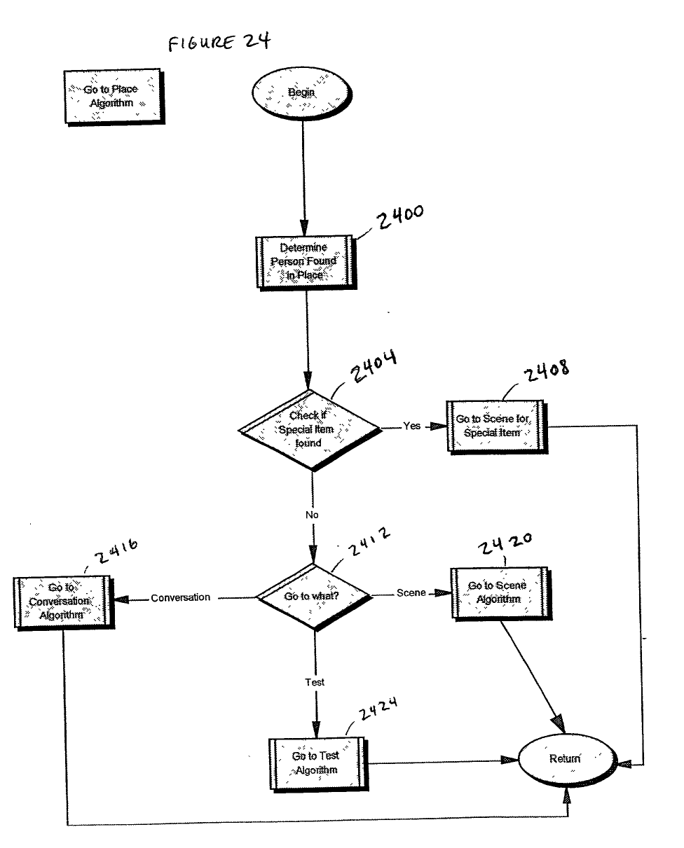

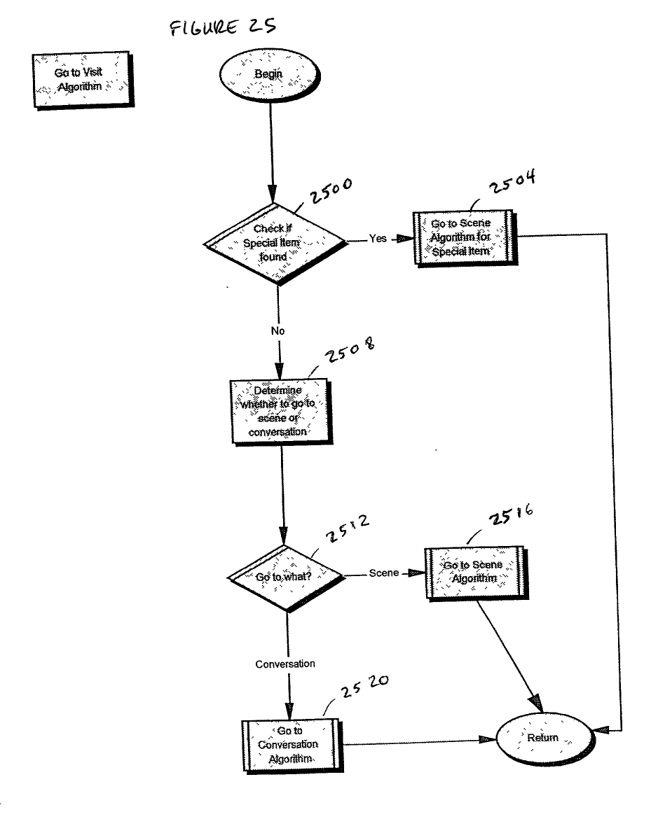

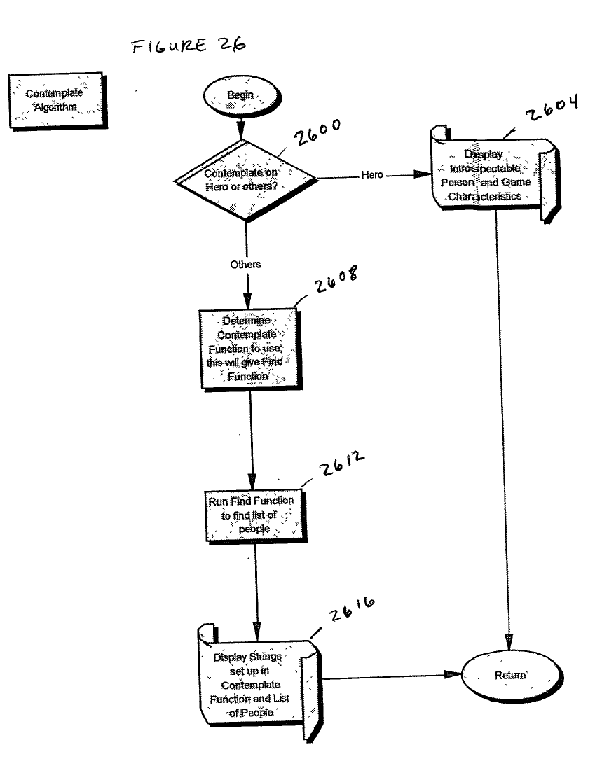

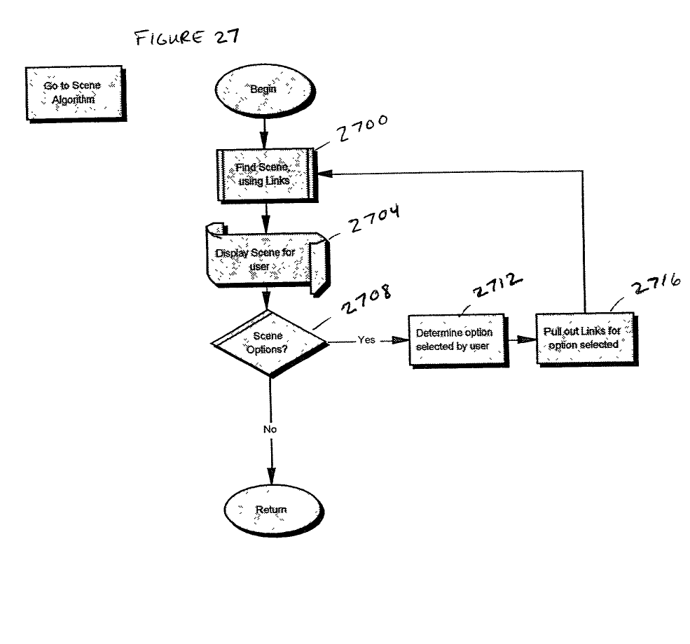

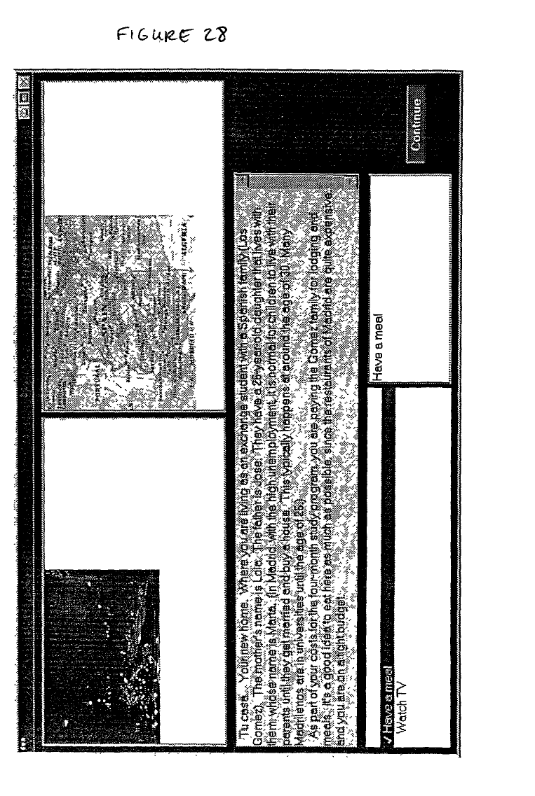

FIG. 1 contains a high-level overview of the inventions and processes. A computer 100 comprises content-creation software which may be used to create an interactive book, game, or test 104. The creation process is described in more depth below with respect to FIGS. 2 - 14. The file created in book, game, or test 104 could be stored onto a disk, CD-ROM, or other storage device, or might be saved to hard disk and uploaded to FunEducation.com's Internet site 108, where it could be distributed to others. Users, across the world, could then download the authored work 112, and play the game, read the book, or take the test (depending on the file). The file might be free or sold to the user. In the case that it is a priced work, if the user tried to make a copy of it and send it to a friend, the friend would receive an evaluation version 116, and be instructed as to where the work could be purchased.

FIG. 2 describes some of the relationships between some of the databases in the software. (The table below gives more detailed information about the databases and their fields.) In table 200, we begin with the Places database, which contains many fields, but we highlight only two of them (People Found, and What to Call). The fields for People Found could contain either an individual person or a Find Function (a group of People with similar characteristics). All of these are indexed links to the databases of People 204 and Find Functions 212. The database for People 204 contains a number of fields, such as Name, Picture, Sound, and Person Characteristics 208. These characteristics are given by the database for Person Characteristics 208, where each characteristic can be defined dynamically by the Author, and can include strings, numbers, lists, indexes to People, and indexes to Places. In the database of Find Functions 212, a set of preconditions 228 is listed that determines which people will be found.

Returning to the database of Places, another important field defines what will be called when the User goes to this place. Will it be a Scene (216), a Conversation (232), or a Test (not included in figure). If it is a scene, then this place will have a set of links that index different scenes from the Scenes database 216. The scenes database contains a set of fields for displaying the scene to the User. Exemplary scenes are Parsed Text (which is the text that the user will see, but may include text that pulls information from the databases), Changes 220 (which describes precisely which changes will occur in the databases when this scene is called), and Links 224. The Links database 224 contains the indices to future scenes that may occur, the chance that those scenes may occur, and the preconditions 228 necessary for them to occur. The Preconditions database 228 uses information in the People, Person Characteristics, Places, and Game Characteristics databases.

The final databases described in this figure are for Conversations 232. Three databases make up what is called a conversation: Topics, Statements, and Responses. The Responses database 236 is similar to the others. Some of its important fields are for the Topic, Parsed Text, Preconditions, Percentage Chance, and Change. Each response in the database is associated with one topic, contains parsed text that will be displayed to the User, may have a set of preconditions that must be true for the response to occur, has a percentage chance that it will occur (given preconditions are true), and has a set of changes that will occur to the databases if the response occurs.

| Database Table | Field | Description |
|---|---|---|
| Places | Name | String name of Place |
| | Comments | Array of strings about describing |
| | | Place |
| | Known by Hero | Boolean; if true, User can go to place |
| | People Found | Array of structures, each containing: |
| | | Whether Find Function or Person; |
| | | Index of Find |
| | | Function or Person; Percentage |
| | | Chance |
| | Multimedia | Path for image, video, sound, etc. file |
| | Sound | Path for sound file |
| | Go to what? | Integer: 0=Conversation, 1=Scene, |
| | | 2=Test |
| | Links | Array of structures, each containing: |
| | | Index for scene to go to |
| | | Index for precondition set to use |
| | | Percentage chance |
| | Topics | Array of integers, indexing which |
| | | topics to use if place goes to a |
| | | conversation |
| | Test Group | If place goes to test, index of which |
| | | test group to pull questions from |
| | Test Changes | If User passes test, index of set of |
| | | changes to apply |
| | Score to Beat | Score that User must have to pass test |
| People | Name | String, name of person |
| | Image | Path for picture of person |
| | Sound | Path for sound associated with person |
| | Individual | Array of strings that will be same size |
| | Person | as the number of person |
| | Characteristics | characteristics; string values are |
| | | interpreted based on settings for each |
| | | person characteristic |
| Person | Name | Name of Characteristic |
| Characteristics | | |
| | Type | Is this characteristic represented by |
| | | text, a number, a list, an index to |
| | | a person, place, etc. |
| | List | Array of strings (if type is set to list) |
| | Default Text | String (if type set to text) |
| | Default Value | Numeric (if type set to number, list, |
| | | or index) |
| | Maximum | Numeric (if type set to number) |
| | Minimum | Numeric (if type set to number) |
| | Introspectable | Boolean; can Hero know about this |
| | | characteristic when Contemplating? |
| Find Functions | Name | String name of function |
| | Precondition | Index of set of preconditions |
| | | necessary for person to be included |
| | | in group |
| | Group to pull | 0=All People; 1 or more=Index of |
| | from | Find Function |
| Scenes | Title | String title of scene |
| | Parsed Text | Text that User will see, including |
| | | special characters that indicate |
| | | formatting or the pulling |
| | | of data from databases |
| | Multimedia | Path where image, video, or sound |
| | | file is located that is included |
| | | in scene |
| | Sound | Path where sound file is located that |
| | | is included in scene |
| | Other Pic | Integer to tell software to use picture |
| | | of Hero, Encountered Person, |
| | | Place, etc. |
| | Other Sound | Integer to tell software to use sound |
| | | of Hero, Encountered Person, |
| | | Place, etc. |
| | Change | Index to set of changes to apply to |
| | | databases when scene occurs |
| | Scene Links | Array of Structures including: |
| | | Option text (that Hero will see) |
| | | Precondition for text to arise |
| | | Links to use if option selected |
| | | (each link contains: |
| | | Scene Index to use |
| | | Precondition Index |
| | | Percentage Chance) |
| Changes | What to | Integer specifying type of change |
| | change? | (person, place, |
| | | item, game characteristic, game over, |
| | | etc.) |
| | First Item | Depending on what is being changed, |
| | | this will |
| | | index a particular database; for |
| | | example, if a person is to be changed, |
| | | first item will be the index of |
| | | that person |
| | Second Item | Index, depending on type |
| | Third Item | Index, depending on type |
| | Fourth Item | Index or value, depending on type |
| | New Value | Index or value to set the |
| | | database's element to |
| Group of | Set of Changes | Array of Indices in Changes |
| | Changes | Table; this array |
| | | defines the entire set of changes that |
| | | will occur (called by Scenes, |
| | | Responses, Place Tests, etc.) |
| Group of | Set of | Array of Indices in Preconditions |
| Preconditions | Preconditions | Table; this array |
| | | defines the entire set |
| | | of preconditions that must |
| | | be true for the set to be true (called |
| | | by all tables that index preconditions; |
| | | they are indexing this table, |
| | | and it indexes the preconditions table) |
| Preconditions | Who to check | Integer indexing person to check or |
| | | game characteristic (=−10) |
| | Characteristic to | Index of the characteristic being |
| | check | checked |
| | Comparison | How do you want to compare this |
| | | value? (equal, not equal, |
| | | greater than, less than, etc.) |
| | Compare to | Compare to a fixed value or another |
| | what? | characteristic? |
| | What value? | Used for fixed value, or as index for |
| | | a second person if comparing with |
| | | another person's characteristic |
| | What | The other characteristic used in |
| | characteristic2? | the comparison |
| Topics | Topic | String |
| Statements | Topic | Index |
| | Statement Text | Parsed text |
| | Precondition | Index of Group of Precondition |
| | Percentage | Integer Value |
| | Chance | |
| Responses | Topic | Index |
| | Response Text | Parsed Text |
| | Precondition | Index |
| | Percentage | Integer |
| | Chance | |
| | Change | Index to groups of changes |
| | Scene to call | If=0, none; otherwise, index to scenes |
| Contemplate | Allow user to | Integer; 0 = On himself and others, |
| | contemplate | 1 = on himself only, etc. |
| | Characteristics | Integer |
| | to use | |
| | Contemplate on | Array of Structures, each containing: |
| | others | Name of function |
| | | Initial Text |
| | | Closing Text |
| | | Find Function to run (Index) |
| Game Intro | Introduction | Parsed Text |
| | Multimedia | Path to multimedia file |
| | Image | Path to image file |
| | Sound | Path to sound file |
| Game | Name | Name of Characteristic |
| Characteristics | | |
| | Type | Is this characteristic represented by |
| | | text, a number, a list, an index to |
| | | a person, place, etc. |
| | List | Array of strings (if type is set to list) |
| | Default Text | String (if type set to text) |
| | Default Value | Numeric (if type set to number, list, |
| | | or index) |
| | Maximum | Numeric (if type set to number) |
| | Minimum | Numeric (if type set to number) |
| | Introspectable | Boolean; can Hero know about this |
| | | characteristic when Contemplating? |
| Events | Name | String |
| | Time Period | Integer; after how many time periods |
| | | will this event occur |
| | How often | Every Time or only once |
| | Find Function | Boolean |
| | or Person | |
| | Index of FF or | Index; database depends on Boolean |
| | Person | above |
| | Change | Index |
| | Apply to | Boolean; Apply to All or Random |
| | | Sample pulled from Find Function |
| | How many max | Integer; can't apply to more than |
| | | this many |
| | How many min | Integer; must apply to at least |
| | | this many |
| | Chance to apply | Numeric; percent chance that any |
| | | one person pulled from Find Function |
| | | will have occurrence of event |
| | Report News | Boolean; yes or no |
| | Headline | String |
| | Parsed Text for | Parsed text, pulling from database |
| | each person | which people are affected |
| | Precondition | Index, determines which people will |
| | | have articles written about them |
| Goals | Completed | Boolean; yes or no |
| | Precondition | Index; what must occur for goal to |
| | | be considered completed |
| | Scene to call | Index; scene called when goal is |
| | | first completed |
| | Hint | Text hint displayed to user to help |
| | | him/her achieve goal |
| Warnings | Time Periods | Integer; after what time period will |
| | | Warning appear |
| | How often | Every time or just once |
| | Preconditions | Index; what must be true for Warning |
| | | scene to appear |
| | Scene to call | Index; what scene is called if |
| | | Warning appears |
| General Info | Author | String |
| | Date created | String |
| | Date last | String |
| | modified | |
| | Contributors | String |
| | Author Bio | String |
| | Summary | String |
| | Description | |
| | Audience | String |
| | Intended | |
| | Credits | String |
| | Allow others to | Boolean |
| | Edit | |
| | Free or Charge | Boolean |
| | Price | Numeric |
| | Distributable | Boolean |
| | Game Style | Integer; test, game, interactive |
| | | book, etc. |
| | Who is Hero | Integer; created new, one of the |
| | | characters, chosen from all, etc |
| | Heroes possible | Array of Integers; Characters that |
| | | could be selected as Hero |
| | Help User with | Boolean; if true, will show User the |
| | Characteristics | introspectable characteristics of each |
| | | possible Hero to help him/her select |
| | | the Hero |
| Items | Name | String |
| | Description | String |
| | Scene to call | Index |
| | How is it held | Integer; by person, in a place, |
| | | randomly, etc. |
| | Which | Index |
| | person/place | |
| | Precondition | Index to groups of preconditions |
| | Chance to arise | Integer |
| Interactions | Name | String |
| | Time Periods | Integer; after how many time periods |
| | | will interaction occur |
| | How often | Every time or just once |
| | Find Function 1 | Index; to find list for first group of |
| | | people |
| | Find Function 2 | Index; to find list for second group |
| | Chance of | Numeric; percentage chance that |
| | interaction | interaction will occur for each pair |
| | Change 1 | Index to group of changes; applied to |
| | | person 1 if interaction occurs |
| | Change 2 | Index to group of changes; applied to |
| | | person 2 if interaction occurs |
| | Report News | Boolean |
| | Headline | String |
| | Parsed Text for | Parsed text |
| | each person | |
| | Preconditions | Index; to decide which people will |
| | | have articles written about them |
| Visit | Allow user to | Boolean |
| | visit | |
| | Find Function | Index; used to find people that |
| | | are visitable |
| | Button Text | String that the Hero will see; might |
| | | say “Visit”, “Phone Call”, etc. |
| | Chance to | Integer; |
| | encounter | |
| | person | |
| | Links | Array of structures, each containing: |
| | | Scene Index |
| | | Precondition |
| | | Percentage Chance |
| | Allow for | Boolean |
| | Conversation | |
| | Precondition | Index; used to determine whether |
| | | conversation will occur |
| | Topics | Array of indices; what can be |
| | | discussed |
| Time Period | Time name | String; examples: “day”, “week”, |
| | | “light-year” |
| | Actions | Integer; the number of user actions |
| | | that equate to one time period |
| Soundtrack | Title | String |
| | Credits | String |
| | Sound File | Path to sound file |
| Ads | Title | String |
| | Animated GIF | Path to animated gif file |
| | URL link | String |
| | Hypertext | String |
| Test General | Test type | Integer; defines how questions are |
| | | ordered when displayed to user |
| | Test finish | Integer; defines whether user can |
| | | see score and review answers |
| | | immediately, or if he/she saves |
| | | results to file |
| | Password | String; used for encryption |
| | Display | Integer; defined things that are |
| | | displayed to user while taking test |
| | Passing Score is | Integer |
| | Test Groups | Array of strings |
| | Test Time | Numeric; if test is timed, how |
| | | many minutes do the users have |
| | AutoPass | Boolean; defines if Test will stop |
| | | once student has achieved |
| | | a passing score |
| Test Questions | Group | Index to test group |
| | Multimedia | Path to multimedia file |
| | Question | String |
| | Correct Answer | String |
| | Wrong Answers | Array of strings |
| | Explanation | String |
| | Difficulty | Numeric |
| | Value | Numeric |
| | If answered | Integer; defines how to proceed with |
| | wrong | test if question is answered wrong |
| | Subtraction | Integer; defines how many points |
| | style | will be subtracted from user's score if |
| | | they answer the question incorrectly |
| | Student answer | Integer; used by reader software to |
| | | store what the student has answered |
| | | right, wrong, skipped, etc. |

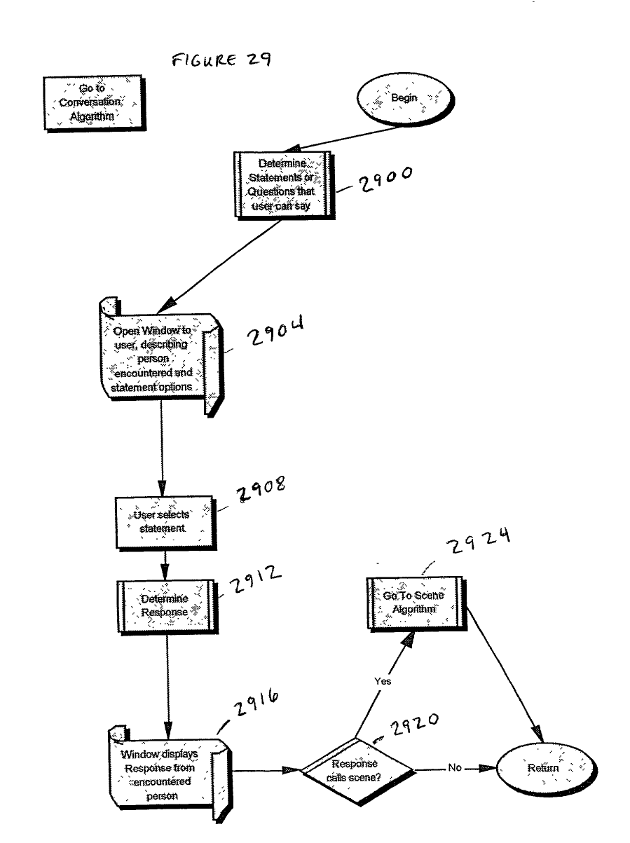

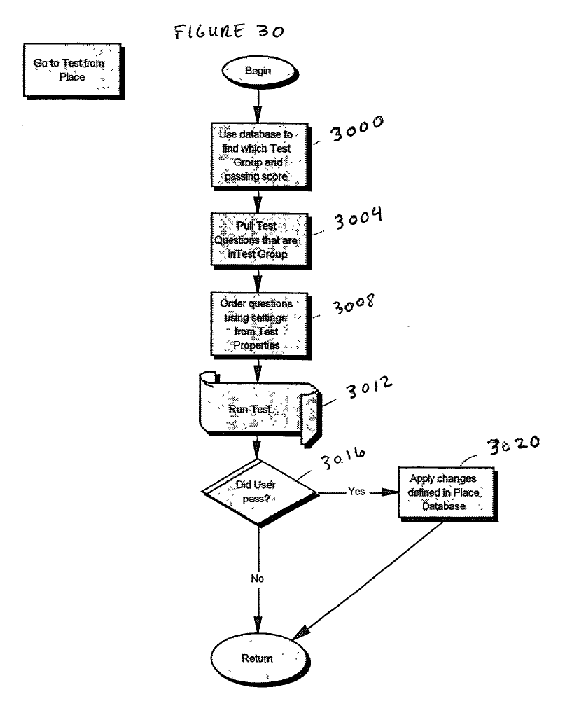

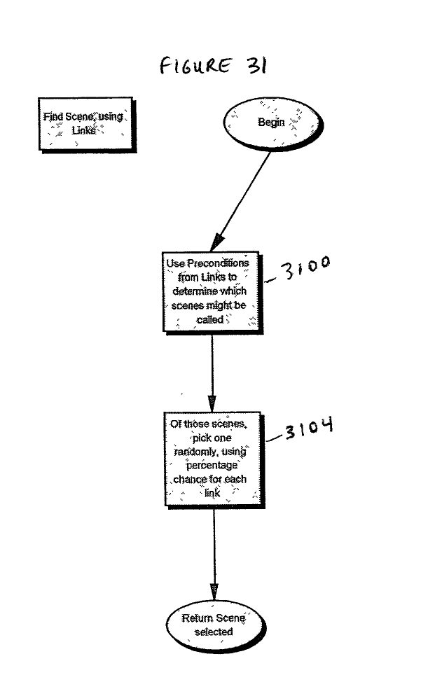

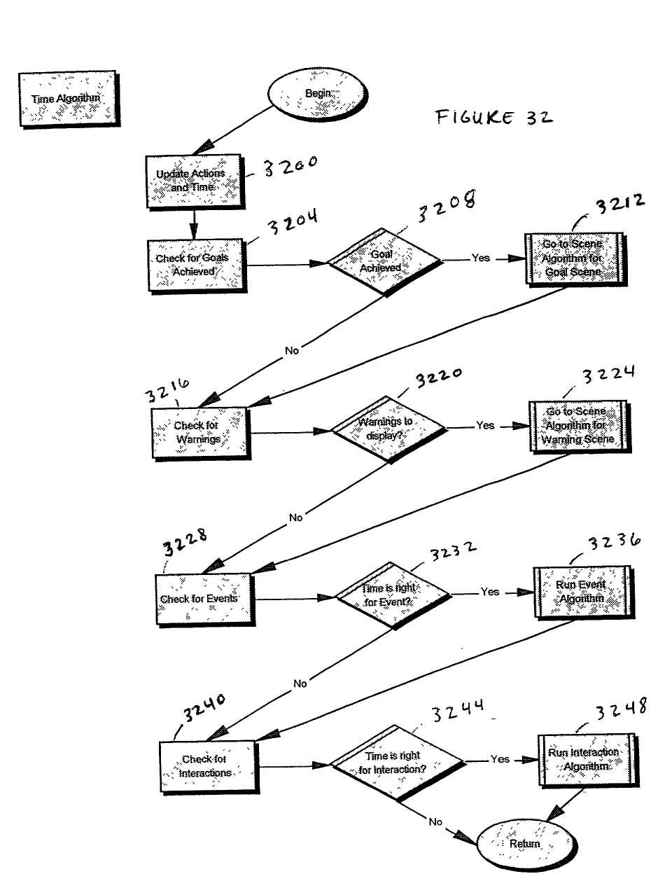

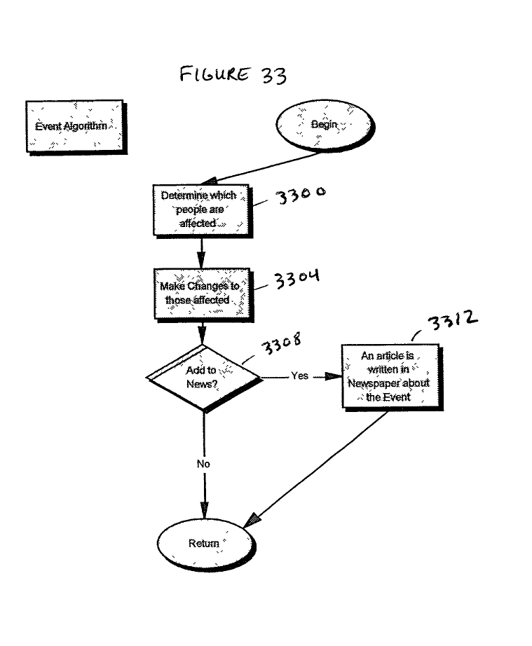

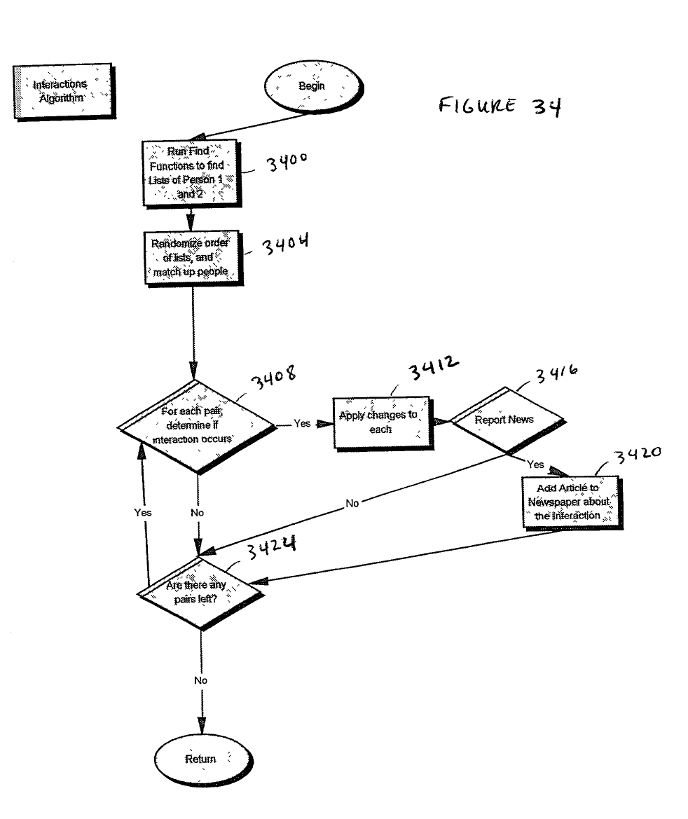

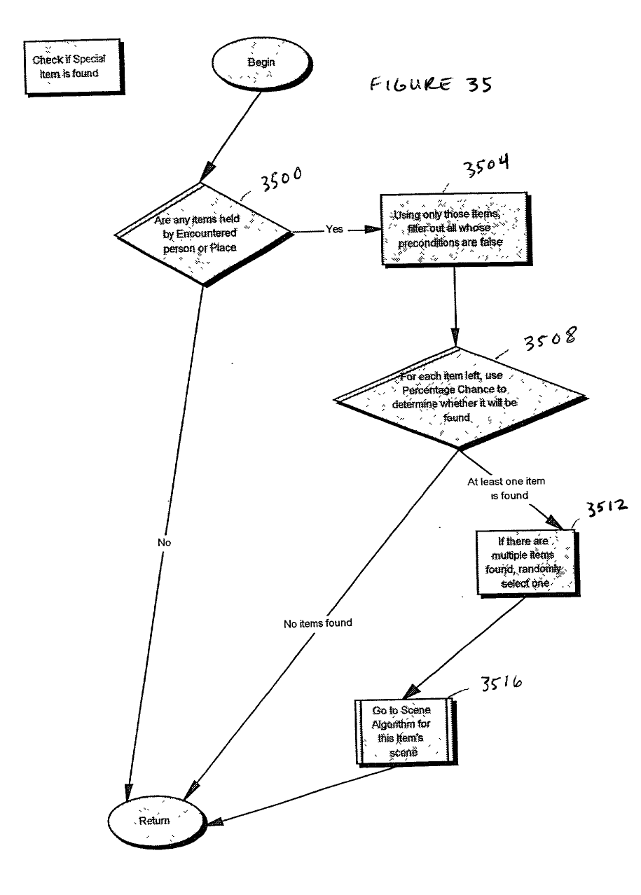

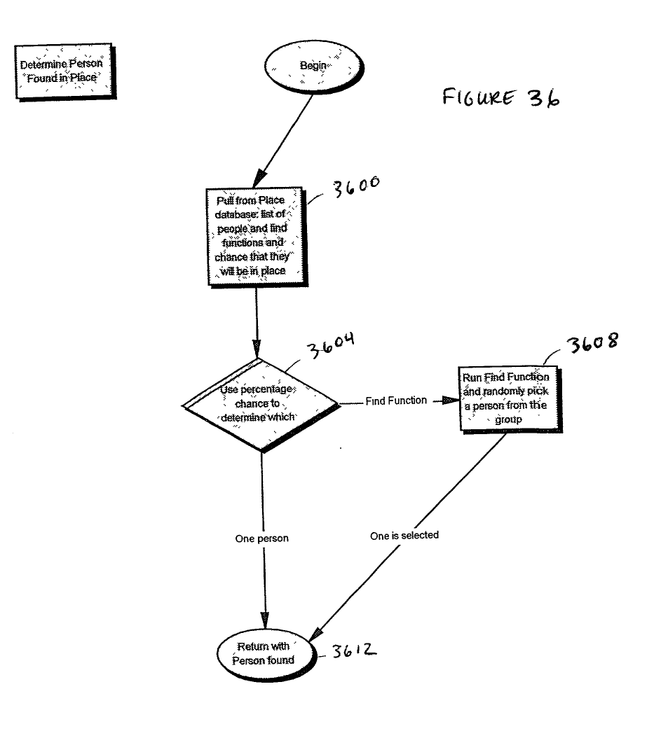

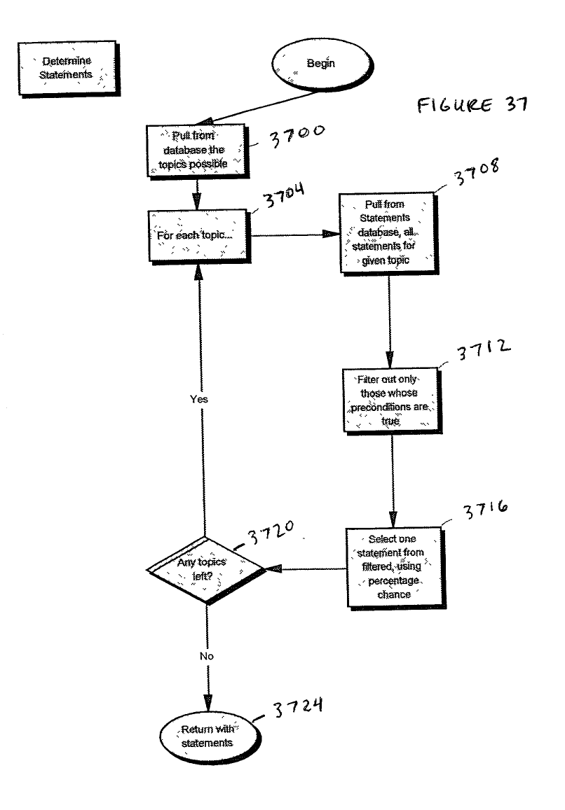

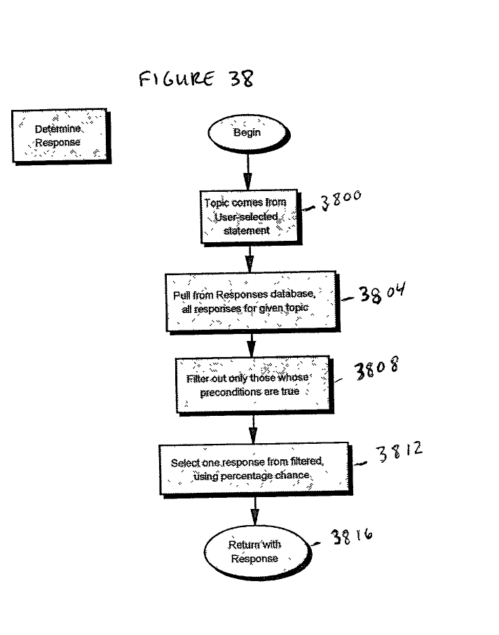

FIG. 3 describes the steps of how to create a content file (test, game, or interactive book) and distribute it to be used by others. In 300, the content creation software is opened, and in 304, a file is opened or created new by the Author. (Some screen views are provided in FIGS. 4 and 5 showing the toolbars and menubars that an Author might see after opening a file.) In 308, the databases can be edited in any order by the Author. (FIG. 2 and the large set of tables that follow it give details of the workings of these databases.) In state 312, the Author can play the file created with the Reader software. This might be done to troubleshoot, debug, or simply enjoy the work created. In state 316, the Author finishes creating and testing the work, and converts it into a distributable file. A distributable file (or set of files) can be read and used (320) on other computers, and stored on various storage devices (CD-ROM, hard disk, floppy disk, internet site, etc.).

FIG. 4 shows a screen display of the Authoring software after the Author has chosen to create a new interactive book or game. The menu bars give the Author access to all of the databases, while the toolbar gives access to the most often used functions (including in this case, the People, Places, and Scenes Editors).

FIG. 5 shows a screen display of the Authoring software after the Author has chosen to create a new test. The menu bars give the Author access to all of the databases used for testing, while the toolbar gives access to the most often used flnctions (including buttons for Test Properties, Groups, and Questions).

FIG. 6 gives more detail for state 308, showing a simplified grouping of the databases 600. The Author can edit any database in any order. If the Author wanted to edit General characteristics of the file 604 (such as Author information, a summary of the file, the audience intended for, credits, a soundtrack, etc. 608), he would use these database editors. The editors that can be used to create an interactive book or game (612) include People, Places, Items, Scenes, Time, Game Introduction, Hero, Events, Interactions, Responses, Topics, Statements, Game Characteristics, Person Characteristics, Goals, Warnings, Contemplation, Visit, Find Functions, etc. 616. Finally, to create a test 620, the Author would use the editors for Test Properties, Test Groups, and Test Questions 624.

FIG. 7 gives an example of the Authoring process. In 700, the Author might enter in his name, a summary of the work, and his biography. In 704, he chooses a group of songs (that are encoded digitally on his computer) that will make up the soundtrack of his work. In 708, he types in the introduction that will appear to the user when the file is first opened, as well as including a sound effect, image, and video file in the introduction. In 712, he begins typing in the characters of the game, specifying a name and picture file for each. He also uses the Person Characteristics Editor (716) to add in any other variables that he wants to keep up with for his characters.

Moving to the 720, he begins to input the places of the interactive book, specifying a name, picture, and sound effect for each. Some of his places will be accessible to the hero at the beginning, and others will need to be discovered. He will specify all of that information here. He also specifies what each place will call. Some will call scenes, and the Author will write those scenes in 724 (including for each scene: the text that will appear, any additional multimedia, and any changes that will occur). Some places will call a conversation 728, and the Author will need to use the Editors for Topics, Statements, and Responses to define the possible conversations. Other places will call a test 732, meaning that when the Hero goes to this place, he will have to take a test on specified material. The Author will specify how the test is set up in Test Properties 736, the test group that will be used by this place 740, and the test questions that will be asked in each group 744.

Moving on to state 748, the Author will set up the Hero of the game. Will the user pick from all characters or a subset of characters? Will the Hero always be the same character? Or will the user type in her name, causing a new character to be created?

In state 752, the Author inputs special items that can be found by the Hero. Some may be held in specific places and only arise if certain preconditions are true. Others may be held by a random person, and arise 10% of the time when that person is encountered. The Author will be able to specify precisely when and under what conditions the items can be found.

State 756 lists some of the other databases that the Author might edit in the creation process. He might set up interactions between characters, events that occur, contemplation finctions for the hero, etc.

FIG. 8 is a screen display of one embodiment of the Places Editor. In this case, there are two places, Austin and San Diego, and the Author is looking at the details for San Diego. We see its name, that it is accessible initially, that no multimedia files are selected for it, that it calls one scene “San Diego Scene 1” (with no preconditions set, and a 100% chance). There could be many more scene possibilities for this place, but in this case, one scene will always be called when the Hero clicks to go to San Diego. Finally, there are two people that are set to be found in the place. (It should be noted that the buttons displayed change depending on what database the place calls. Since it is calling a scene, we see these buttons, but if it called a conversation or test, the buttons would change.)

FIG. 9 is a screen display of the Person Editor. Here, the Author has three people set up, and is currently looking at the details for the character Susie. The Author can change her name, any multimedia files associated with her, and the characteristics currently set up for her (in this case, Age=28, race=white, sex=female, and money=15). Clicking on the button “Edit this Person” would allow the Author to change Susie's characteristics. Clicking on the button “Characteristics” on the bottom of the screen would bring up FIG. 10.

FIG. 10 is a screen display of the Person Characteristics Editor. Here, the Author has defined four characteristics: Age, a number; Race, a list; Sex, a list; and Money, a number. Since Age is highlighted, we can see the details for it. The Author can rename it (from “Age” to something else), can change it from a number to another data type, can change its default values, max and min, and can change whether it is introspectable. If we looked at Sex, we would see a list of two strings “male” and “female”. Race might contain a list of five strings. In all cases, the Author has full power over decided which characteristics will be used, and how they will be represented. If they are lists, he can define which strings make up the list. Like all of the databases, there are no limits to the number of entries. The Author could make 250 characteristics for each person if desired.

FIG. 11 shows a screen display of the Scenes Editor. In this case, the Author has created three scenes, and the current highlighted one is San Diego Scene 1. Looking at the details of it, we see an indicator displaying all databases that index this scene (in this case, it's only indexed by the place “San Diego”). The Author can modify the Scene Title, click on the button “Scene Text” and modify the text displayed to the user, click on buttons like “Multimedia” or “Changes” to define which multimedia files are used in the scene or which changes will occur when the scene is called. In this case, the Author has set up one link (using the “Links” button). This link defines the following: first, the User will see a text option for “See the zoo” when the scene appears; second, if the User clicks on “See the zoo” , she will go to the scene “zoo” 100% of the time. Finally, there is no password set up for this scene. If one were set up, the User would be prompted with the text in the Password Prompt, and would have to answer the prompt with the exact word or phrase specified by Password.

FIG. 12 shows a screen display for Parsed Text. Many of the databases use parsed text, which can include formatting information as well as links to the databases. In this case, the first line of the text says “You run into ˜˜Pe˜Encountered Person˜Name˜˜, who is walking in a very strange manner...” When this text appears to the user, the part “˜˜Pe˜Encountered Person˜Name˜˜” will be replaced by the name of the encountered person. The software will pull the name from the databases and replace it in the text. From the Author's perspective, he simply needs to click on the button “Person”, and specify “Encountered Person” and “Name” from two lists for “Which Person?” and “Which Characteristic?”. It is important to note that the Author can choose this information from a menu instead of having to write it in like a programming language. It should also be mentioned that the parsed text can pull from all databases, not merely names from People.

FIG. 13 shows a screen display for the Preconditions Editor. Here the Author creates a set of preconditions that are used in many of the databases. He can insert person preconditions (which use people and person characteristics) or game preconditions (which use game characteristics). In this case, he has specified that for this set of preconditions to be true, the Encountered Person's age must be less than 25, and the Hero's sex must be male.

FIG. 14 shows a screen display where the Author is selecting a precondition that will go in the set. Using menus and lists, he can choose which person (the list includes Hero, Encountered Person, and all created characters), which characteristic (the list pulls from all person characteristics), which comparison (less than, equal to, etc.), how to compare (to a fixed value or compare with a characteristic of same or another person), and what to compare it with (the value or the person and characteristic). In this case, the Author has selected “Encountered Person” “age” “is less than” fixed value “25”. Note that virtually every part of this GUI is dynamically filled with information from the other databases.

FIGS. 2-14 focused on the Authoring software and the process of making a content file (test, game, interactive book, etc.) FIGS. 15-38 will focus on the reader software, and how this file (which is basically a set of databases) is read and interpreted.

FIG. 15 shows the high-level view of the reader software. The user will first open the file 1500. The software will determine whether the file is a game or interactive book or a test 1504. If it is a test only, the Test Reader software will be run 1508. (FIGS. 16-20 show the Test Reader software in more detail). If it is a game or interactive book, the Game Reader software will be run 1512. (FIGS. 21-38 give more details on the Game Reader software).

FIG. 16 shows the high-level view of the Test Reader. State 1600 displays the test groups and other information to the User. The User can then select a test group (which might also include a group of skipped questions) to test on 1604. The software will then run a portion of the test for that group of questions 1608. Afterwards, a decision state occurs 1612, in which the user can continue the test and choose from other groups, or choose to exit. Depending on the test properties, the User will either see her score and be able to review answers, or she will be allowed to save the test to file 1616. If saved to file, a teacher (possibly the Author) would be able to open the file or a directory of files (for the same test) and see student results 1620.

FIG. 17 shows a screen display of the Test Reader. Here we can see that the student has entered in his name, professor, and class, and has begun the test. In the lower right-hand comer, we see that there are nine total questions, one has been answered, four skipped, and four remaining. A perfect score is shown to be 100, and a good (or passing) score is shown to be 90. More importantly, there is a list box where the student can select which test group he wants to take. Here, we can see that he has already done the questions in the first group, and has selected the second group. Hitting the “Go” button will take him to a screen where the questions are asked.

FIG. 18 describes the procedure for ordering and displaying the questions to the User. In 1800, all test questions for the current group are filtered out. (The current group is the one selected by the User). In state 1804, the questions are arranged in an order given by Test Properties (described in more detail in FIG. 19). In state 1808, the software asks a question to the user. State 1812 determines if the question was answered correctly, incorrectly, skipped, etc., and which question will be displayed next (more details in FIG. 20). In decision state 1816, the software determines if there are any questions left to ask. If so, it returns to state 1808 to continue the loop.

FIG. 19 describes how the questions are arranged, using the setting in the database for Test Properties. In decision state 1900, the database for Test Properties is used to determine the method for ordering the questions (this method was defined by the Author). If the method is “Order typed”, then state 1904 will be called. In this case, we don't change the order of the questions, and we set the opening question to be asked to be the first question in the group 1908. If the method is “Intelligent Ordering”, then state 1912 is called. Here, the software will sort the questions in order of their difficulty level (using the database). It will then set the opening question to be asked to be the middle question in the group 1916. If the method is “Shuffle Questions”, then state 1920 will be called, randomly shuffling the order of the questions in the group. State 1924 will then set the opening question to be the first question of the group.

FIG. 20 shows the procedure for determining the next question. In state 2000 the software will determine whether the user answered correctly, incorrectly, skipped the question, etc. and will add to or subtract from her score. In decision state 2004, the software will check the database of Test Properties to see if AutoPass is enabled. If so, and the User's score is above a passing score, the software will set a Boolean to stop the test 2008 and return. If AutoPass is not enabled, or the User does not have a passing score, then the software will continue to state 2012. This decision state will determine what kind of ordering method is set up. If it is set for “Intelligent Ordering”, then state 2020 will be called. If not, state 2016 will be called. State 2016 increments the test question to be the next one in the group. State 2020 will go to a more difficult question if the User answered correctly (meaning that it will move up in the group to find a more difficult question that hasn't been answered yet). If the user skipped or answered incorrectly, state 2020 will move to an easier question (moving down in the group to find an unanswered question). In both cases, if an unanswered question is not found moving in the set direction, then the software will find an unanswered question that is as close to the same difficulty as the previous. Moving on the state 2024, the software will check to see if another question is left unanswered. In this state, the software will also check the test questions database to see if this question was answered wrong. If so, is the question set up to exit the group when answered wrong? If so, then state 2024 will return a “No” and move to state 2008. Otherwise, the software will simply return whether there are questions remaining or not.

FIG. 21 describes the high level flow of the Game Reader. State 2100 is the initialization state. In this state the User selects to either play a new game or open a previously saved game. If a new game is selected, then initialization will occur on the characters (and their characteristics), places, items, goals, time period, etc. All controls and graphical interfaces will be set up for their initial state. (Note that most all of this information comes from settings made by the Author in the databases). After initialization, state 2104 is run. This is the main loop and will be described more fully in the next figure. When the User exits the main loop, state 2108 occurs, allowing the User to save his current state in the game.

FIG. 22 describes the main loop of the Game Reader. In 2200, the loop begins, and moves into 2204 to run the Time Algorithm (FIG. 32). The Time Algorithm updates the time period, and checks for goals, warnings, events, and interactions. After the time algorithm, decision state 2208 is where the User selects an action. She might go to a place, contemplate, visit, or exit (among other things). If she selects to contemplate, then state 2212 will be run (FIG. 26), giving her information about her character or other characters in the game. After contemplation, state 2200 will be called again. If she selects to visit, then state 2216 will be run (FIG. 25), taking her to encounter the person chosen, either in a scene or conversation. After visiting, state 2200 will be called again. If she selects to go to a place, then state 2220 will be run (FIG. 24). Here, she will go to a scene, conversation, or test defined by the place. Upon returning from the place, state 2200 will be called again. Finally, the User is able to exit at any time from this main loop, which would stop the game.

FIG. 23 is a screen display demonstrating various aspects of the game. In this case, it is a game to teach students about Spanish and Madrid. Any ads would be shown in the upper-left-hand corner. (In this case, there are no ads, but if there were any, they would be pulled from the Ads database.) Directly underneath is a listing of places where the Hero can go. (These places were defined by the Author, and the only ones listed are those that are set to be accessible.) Underneath the places, there is a list of characters that the Hero can visit (in this case, the Author has defined the text to say “Phone Call” ). (The people that make up this list are pulled from the Find Function defined for the Visit database.) Underneath the visit list is a selection box for contemplation. The User could select to contemplate on herself or using any of the contemplation functions that the Author might have defined. And underneath the contemplation input is a text indicator showing a hint for the next goal. (This hint was pulled from the Goals database created by the Author).

On the right-hand side of the window, starting at the top is an indicator showing the current time period for this User's game. In this case, it is “Week 1”. As the User goes to more places or talks to more people, time will increment (as defined by the Author). Underneath the time period indicator, there are buttons for the User to see the Introduction again, view the Credits, read the Newspaper, or stop the Soundtrack. Below these buttons, there is a picture of a bullfighter (which is the picture defined for the place “Plaza de Toros”- Spanish for “Bullfighting Stadium”). Because the User just highlighted this place (Plaza de Toros), this picture appears.

FIG. 24 details the algorithm used when the User chooses to go to a place. First, in 2400, the software will determine the person found in the place (more in FIG. 36). In decision state 2404, a check is done to see if a special item is found (more in FIG. 35). If a special item is found, the scene is called for that item 2408. (More on the scenes algorithm in FIG. 27). If a special item is not found, then the decision state 2412 comes up. Here, the places database is used to decide what to do for this specific place. Does the software go to a scene, conversation, or test? After deciding, state 2416 is called for conversation (more in FIG. 29), state 2420 is called for scene (more in FIG. 27), and state 2424 is called for test in place (more in FIG. 30).

FIG. 25 details the algorithm used when the User chooses to go visit. First, in decision state 2500, a check is done to see if a special item is found (more in FIG. 35). If a special item is found, the scene is called for that item 2504. (More on the scenes algorithm in FIG. 27). If a special item is not found, then state 2508 is run. Here the Visit database is used to determine probability that the person will be encountered. It also ensures that there is a scene or conversation set up to go to. After calculating the probability, if the person is not encountered, then exit the algorithm. If the person is encountered, then move to decision state 2512. Here, the Visit database is used to decide what to do for this specific place. Does the software go to a scene or conversation? After deciding, state 2516 is called for scene (more in FIG. 27), and state 2520 is called for conversation (more in FIG. 29).

FIG. 26 describes the algorithm for contemplation. In decision state 2600, the software determines whether the User selected to contemplate on herself or use a contemplation function. If she chose to contemplate on herself, then state 2604 is called, which will pull from the Contemplation, People, and Person Characteristics databases to determine how many characteristics to show and which ones are introspectable. The algorithm will then randomly display the number defined. If decision state 2600 finds that the User wanted to contemplate on others, state 2608 will be called. This pulls from the contemplation database the Find Function needed to run for this contemplation fimction. In state 2612, we will then run the Find Function to get the group of people. In state 2616, the software will display to the User the text defined by the contemplation function, including the list of people found.

FIG. 27 describes the algorithm for going to a scene (as called in various places like the Go to Place, Go to Visit, and Time Algorithm). In the first state 2700, the software will determine which scene to use. Some flnctions send a single scene index and others send a group of links. This state (described more fully in FIG. 31) will determine one scene to use. Moving on to state 2704, the Scenes database will be accessed, and the parsed text will be shown to the user, including any multimedia and options. Decision state 2708 asks if there are any scene options. If not, it will exit the algorithm. If there are options, it will wait for the User to select one of them. After selection, it will move to state 2712, determining with option was selected and accessing the scenes database to find the Links associated with that option 2716. It will then pass the Links back to state 2700 to begin the loop again.

FIG. 28 shows a screen display for one of the scenes in the Spain game. This figure corresponds to state 2704 from FIG. 27. In this case, the User has selected to go to “Tu casa” (Your home). We can see two images that are associated with this scene, as well as the scene text that is displayed. At the bottom of the screen, there is a list box showing the options for the User to pick from. In this case, the User has selected “Have a meal”. (If she then hits the continue button, it will correspond to state 2712 in FIG. 27.)

FIG. 29 shows the algorithm for a conversation (which might be called by the “Go to Place” or “Go Visit” algorithms). State 2900 determines which statements the User will be able to say. (This is described in more detail in FIG. 37). State 2904 will then open a window to the User, describing the person encountered and listing the statement options. In state 2908, the User selects one of the statements to say to the encountered person. State 2912 will then determine the response of the encountered person (more details in FIG. 38). State 2916 displays the response to the User in a graphical window. Decision state 2920 checks the Responses database to determine if a scene needs to be called. If so, the appropriate scene will be called in state 2924 (more details in FIG. 27). If not, the algorithm will exit.

FIG. 30 shows the procedure for running a test when a place links to a test. In state 3000, the software pulls from the Places database to determine which Test Group to use, and what is a passing score. State 3004 will then use the Test Group defined to pull out the Test Questions. State 3008 will then order the test questions using the ordering method defined by test properties (FIG. 19 details this). State 3012 will then run the test (exactly like states 1808, 1812, and 1816 in FIG. 18). At the end of the test, decision state 3016 will determine if the user passed or not using the passing score set up in the Places database for this place and the score obtained from the answers to these questions. If she did not pass, the algorithm will exit. If she did pass, then state 3020 will apply the changes defined in the Places database for this place.

FIG. 31 shows the procedure for finding a scene, using Links. In state 3100, each link is checked to see if its preconditions are true. Those links whose preconditions are not true are filtered out. State 3104 pulls from those links whose preconditions are true. The software will access the probability for each one (using the percentage chance variable that each contains) and will randomly choose one of the links (after weighing them with their percentage chances). The algorithm will then return the scene selected.

FIG. 32 details the Time Algorithm. State 3200 will increment the actions and determine if a new time period has occurred (using the Time Period database). State 3204 will check for any goals achieved. This process involves looking at all goals in the Goals database that have not been completed. Any of these which have their preconditions met will cause decision state 3208 to return a “yes” and invoke state 3212 which calls the appropriate scene for the goal. After the goals are checked, state 3216 will check for warnings. The software will only check for warnings if it is a new time period. (For example, the Author might set up time periods to be in “Days” and 4 actions equals one day. In this case, warnings aren't checked after every action, but instead after every day, which occurs after every four actions.) So, if it is a new time period, the Warnings database will be accessed. For each warning that is set to occur on the given time period, its preconditions will be checked. If these preconditions are true, then state 3220 will send a “yes” to state 3224, causing the appropriate scene to be called for this Warning. After checking all warnings, state 3228 will be run, which will check for events. The software will only check for events if it is a new time period (just like Warnings). The decision block 3232 will determine if the time is right, looking at all Events in the Events database and finding any that are supposed to occur. For each that should occur, state 3236 will be run, which will run the event algorithm (more in FIG. 33). After checking all Events, the software will move to state 3240 to check for Interactions. This process is exactly like the one for events, only running if it is a new time period. Decision block 3244 will determine if the time is right, looking at all interactions in the database. For each interaction whose time is right, state 3248 will occur, running the Interaction algorithm (more in FIG. 34). When this is done, the algorithm will exit.

FIG. 33 details the Event Algorithm. State 3300 will determine which people are affected, using the settings in the Event database. In particular, the software will determine if the event happens to an individual or a group (Find Function). If it is set up for a group, the database will specify whether all people in group are affected, or a random subset. If it is a random subset, the database will specify the probability, maximum and minimum numbers. State 3304 will make changes to those people affected, using the change set up in the Event database. State 3308 will check if this event causes news, and if so, will check the preconditions for the news to occur. If both are true, then state 3312 will occur, writing an article in the newspaper, using the parsed text and headline defined in the event. When all people in the group have been checked, the algorithm will exit.

FIG. 34 details the Interactions algorithm. In state 3400, the software accesses the database to determine which Find Functions to run. It then creates two lists, one for person one, and the other for person two. State 3404 will randomize the order of the two lists and match up pairs. The matching up involves taking the first person from each list and making them a pair, then taking the second person from each list, then the third, etc. until one of the list runs out of people. If any pair is made up of two of the same person, the pair is discarded. Any unmatched people are also discarded as we move to state 3408. Here, we take each pair and check for an interaction, using the probability set up in the Interactions database. Using this probability, the software will randomly determine which pairs have an interaction and which don't. If the pair has an interaction 3412, the software will apply the changes set up in the database. Change 1 affects Person 1. Change 2 affects Person 2. Decision state 3416 determines if news occurs using settings and preconditions in the database. If so, state 3420 adds an article to the newspaper. State 3424 ensures that all pairs are checked for an interaction.

When all have been checked, the algorithm exits.

FIG. 35 details how the software checks to see if a special item is found. First, it determines which place the Hero is in, and who the encountered person is. State 3500 scans the Items database to determine if any items are held by the encountered person or in the current place. If so, the group of possible items is passed to state 3504, where all items whose preconditions are not true get filtered out. State 3508 takes those items remaining and uses the percentage chance variable defined in each item to determine which will be found. State 3512 ensures that if multiple items are left and found, only one will be picked. State 3516 then calls the appropriate scene for this found item, as defined in its database. The algorithm is then exited.

FIG. 36 details how to determine the person found in a place. State 3600 uses the Places database to get the Person Found structure, which can include various people or Find Functions as well as a percentage chance for each. Decision state 3604 then uses all the percentage chances set up and randomly picks one of them. If a Find Function is selected, state 3608 is run, which will run the Find Function to get the list of people and randomly pick one person from the list. This person is then sent to state 3612 and the algorithm is exited. If instead, an individual is selected, then this person is sent to state 3612 and the algorithm is exited.

FIG. 37 details how a set of statements is determined for use in a conversation. This algorithm might be called by the Go to Place or Go Visit algorithms. State 3700 will use the appropriate database (either Places or Visit) to determine which topics can be discussed in this conversation. State 3704 then begins a loop for each topic. First, state 3708 will pull out all statements from the Statement database that have the given topic. Next, state 3712 will filter and keep only those statements whose preconditions are true. State 3716 will then select one statement from those remaining, using the variable percentage chance to weigh its selection. Decision state 3720 then asks if any topics are left. If so, we return to state 3704. If not, the algorithm is exited with a list of statements to use.

FIG. 38 details how a response is determined. This is called in the course of a conversation, and the User has just selected a statement to say to the encountered person. State 3800 determines what topic that statement belongs to. State 3804 accesses the Responses database that pulls out all responses for the given topic. State 3808 will filter and keep only responses whose preconditions are true. Using that group, state 3812 will select one response, randomly picking one from the group after weighing them, using the variable percentage chance. In state 3816 the algorithm exits, returning with the response selected.

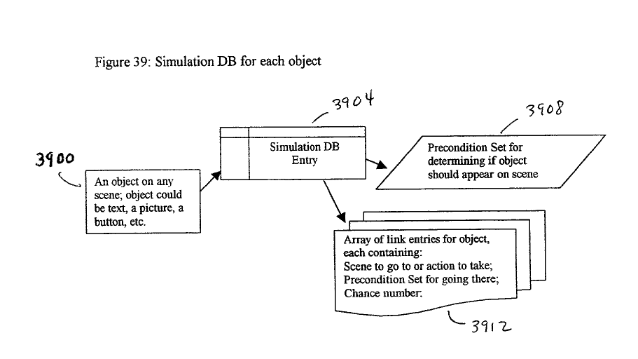

FIG. 39 details the simulation database and properties for objects in a scene or conversation. State 3900 sets forth objects, including text, pictures, and buttons, that the User manipulates. State 3904 determines if an object should appear in a scene or conversation by checking to establish the truth of preconditions 3908. State 3912 details the array of values that determine what to do if the object in state 3900 is selected. For example, if the User clicks on a picture in the scene, what should happen? FIG. 39 defines a set of possible actions. Each item in the set is comprised of: A. a scene or conversation to go to or action to take, such as opening an application or moving to a hyperlink; B. a set of preconditions that must be true for this action to be possible; and C. a weighted number which is used to determine what percentage chance there is to take this action over other possible actions.

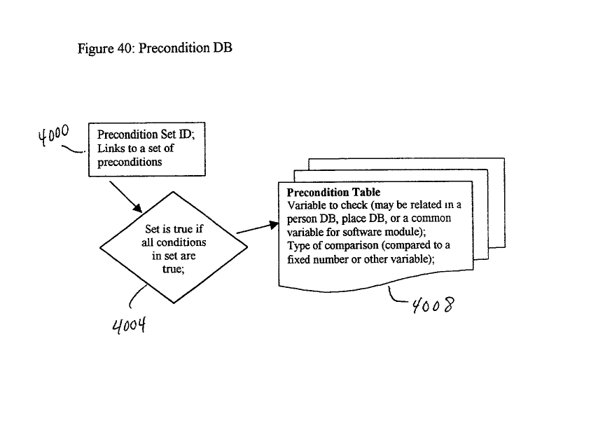

FIG. 40 details the precondition database and defines what conditions must be true for a Precondition Set to be true. State 4000 shows the identifying set that can contain any number of preconditions. State 4004 determines if all conditions in a set are true by comparing the variables in state 4008. The variables in state 4008 can come from any number of databases, and can be compared to fixed values or other variables. For example, in FIG. 14, the User is creating a precondition (through menu selections) that specifies that the encountered person's age must be less than 25. In FIG. 13, the set of preconditions includes two preconditions: the one above, and the condition that the Hero must be male.

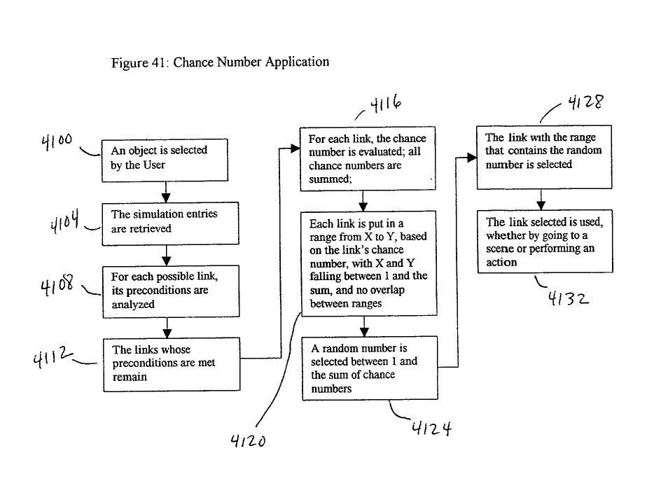

In a preferred embodiment, the User selects an object 4100 and simulation entries are retrieved 4104 as shown in FIG. 41. For each possible link, the preconditions for that link are analyzed 4108 and the links that meet the preconditions remain as an option. For each remaining link, the chance number is evaluated and all chance numbers are summed in state 4116. Then, each link is put in a range from X to Y, based on the chance number of the link, where X and Y fall between 1 and the sum, and no overlap between ranges as described in state 4120. A random number is selected between 1 and the sum of chance numbers 4124 and the link with the range that contains the random number is selected in state 4128. Afterwards, the link selected is used either by going to a scene or performing an action 4132.

While the above detailed description has shown and described the fundamental novel features of the invention as applied in various embodiments, the disclosed embodiments of the invention are merely illustrative and do not serve to limit the scope of the invention set forth in the following claims. Those skilled in the art may practice the principles of the present invention without departing from the intent of the invention.

What is claimed is:

1. A method of creating computer-based simulations, using database entries and menu selections, rather than writing complex software code, comprising:
an authoring tool for building computer-based learning software or games;
a set of scenes created by said authoring tool;
a set of objects, such as text and multimedia comprising each scene; and
a simulation database entry for each object.

2. The method defined in claim 1, wherein objects are displayed within a scene based on a set of preconditions.

3. The method defined in claim 1, wherein variable changes defined by the simulation database are applied as a new scene is entered.

4. The method defined in claim 1, wherein the simulation database inspects each entered object by iteratively moving through all possible links to determine a set of preconditions for a link.

5. The method defined in claim 1, wherein the simulation database calculates the chance value for a link, giving a range (X to Y) for a link with no overlap of other ranges, finding a random number between 1 and the sum of the chance value, and selecting a link with a range containing the random number.

6. The method defined in claim 1, wherein the object selected queries the simulation database to determine link destination.
